(19) United States
(12) Patent Application Publication
(10) Pub. No.: US 2016/0200634 A1
(43) Pub. Date: Jul. 14, 2016

(54) BIO-AVAILABLE MINERAL FERTILIZER AND DERIVATIVE APPLICATIONS, INCLUDING PRODUCT PROCESSES

(71) Applicant: AVALON ALLIANCE INC., Kelowna (CA)

(72) Inventors: Laurel Lynn Zaseybida, Kelowna (CA); Bonnie Allison Wilkes, Kelowna (CA)

(73) Assignee: AVALON ALLIANCE INC.

(21) Appl. No.: 14/966,414

(22) Filed: Dec. 11, 2015

Related U.S. Application Data
(60) Provisional application No. 62/091,305, filed on Dec. 12, 2014.

(51) Int. Cl. C05B 17/00

(52) U.S. Cl. CPC C05B 17/00

(57) ABSTRACT

A bio-available mineral fertilizer composition includes a full-spectrum of essential mineral and carbon-organic nutrients for soil and plant health incorporated into a composite blended media chosen from the group which includes liquid, powder, granular.

### BACKGROUND

### Local and Global Issues Include

1. Soil Nutrient Depletion caused by massive agri-industry leeching out and exhausting nutrient reserves from the earth. This is a result of aggressive growing practices that focus on “chemical inoculated” crops that accelerate plant growth but produce poor nutrient values in their yields. This process is repeated over and over compounding the problem without returning appropriate sustenance to the soil.

2. Soil and Water Contamination from conventional chemical agriculture and polluting industries devastates healthy ecosystems in their ability to support life, which directly leads to poor human and animal health. Soil degradation globally is illustrated in FIG. 1.

3. Need for indirect (soil/plant-based) and direct (oral) nutrient and detox supplementation to restore human and animal health and reverse the alarming rise in related diseases and chronic conditions. While organic certified food may be relatively free of toxins it can still be deficient in essential minerals and trace elements.

4. Finding the Solutions to Effectively Support Transition from conventional depleting methods of farming, forestry and watershed management to sustainable and healthier practices while maintaining productive yields and even improving profitability.

5. Educating the public, regulatory officials and industrial sector with ongoing scientific demonstration activities and customer extension services to teach new application methods, ecological health and sustainable land management.

### What is Organic Agriculture?

The principles of organic agriculture are to produce food using production methods that emphasize the use of renewable resources, natural minerals and the conservation of soil and water to enhance environmental quality for future generations. Organics also includes the production of nutritious animal feed and aquaculture.

The intent is to promote and enhance agro-ecosystem health through encouraging agricultural production systems to manage their resources cyclically and to maintain soil fertility in the long term while minimizing external inputs and avoiding the use of chemical fertilizers, pesticides and herbicides.

While organic farming is generally preferable to chemical agriculture in many ways, some intensive forms of organic farming using manure and slaughterhouse by-products also contribute to pollution and may have health risks and animal welfare issues. Moreover, composts and other commonly used organic amendments may still not achieve the level of mineralization required for optimal plant growth, nutrient density and resilience.

### Impacts of Chemical NPK Fertilizer:

Use of conventional chemical fertilizers in agriculture has contributed to depletion of vital nutrients in food crops, soil acidification and degradation, reliance on toxic pesticides and herbicides, eutrophication of waterways and adverse climate changes. The ecological food web can become seriously compromised, resulting in “dead” rather than “living” soil. Specific impacts include the following:

1. acidity destroys the friability of soil and increases surface compaction

2. increased impermeability prevents rain water from entering the soil

3. acidity adversely affects soil pH which in turn impacts beneficial microorganisms

4. chemicals harm earthworms, the “great aerators and conditioners of the soil”

5. chemicals harm beneficial insects like bees and ladybugs

6. increased plant weakness and diseases through damage to mycorrhizae fungi roots

7. increased fungal and bacterial diseases through excessive NPK and lack of trace elements

8. wasteful chemical leaching into ground water and water bodies

9. agricultural run-off and sprays damage ecological balance and wildlife habitat

10. instant uptake of water-soluble NPK can overwhelm and “burn” plant foliage

11. lower nutritional value and less flavor in fruits, vegetables and other crop

12. adverse impacts on climate, air quality and atmosphere

One of the key objectives of the present invention is to rebuild the foundation of agriculture by restoring soil with a new class of non-toxic, user-friendly Bio-Mineral product lines, with derivative applications in, for example, forestry and watershed management, industrial clean-ups, animal feed and health supplements.

### Objectives Also Include:

1. Providing a full spectrum of minerals and other nutrients essential to good health (92+ elements, not just NPK)

2. Improving soil structure/water retention, remediating toxic contaminants and supporting the ecological food web;

3. Increasing the nutrient uptake density, biofield energy, climate resilience and immune system of plants;

4. Maintaining product purity and safety (organic permitted ingredients and no animal by-products)

### SUMMARY

Applicant's Bio-Minerals are rock and sea nutrients optimally blended with natural biostimulants in powered, granular and liquid applications. The bioavailable composite products are intended to restore soil structure, increase plant yields, neutralize toxic contaminants, protect the ecological food web and replenish vital nutrients. The products are all-natural combinations of macro and trace minerals, microorganisms, carbon-based humic substances and other biostimulants that promote nutritional and energetic health. They are formulated and manufactured so that mineral-rich nutrition is bioavailable to plants in liquid format and in dry powder/granular applications. Food security and nutritional wellness for both people and animals is also enhanced.

The innovation is two-fold, relating to both novel ingredient composition and manufacturing process, with extraordinary range of “utility” or “usefulness” that transcends conventional product categories. Bio-minerals constitute a new category of multi-functional product with a wide range of derivative applications requiring whole systems thinking and interdisciplinary synthesis. This is a novel biochemical and energetic (electromagnetic/subatomic) process and product by process that accelerates and enhances soil-building and other natural processes which in turn provide whole solutions for agriculture, health and the environment.

A base of powdered rock and seawater minerals provides a full spectrum of macro and micro-nutrients and trace elements (92+ elements is highest potential range). Biological organisms (plants, animals, humans) in order to function at their highest potential require appropriate integration of all these elements, not an overdose of a few macro elements as is done in the application of chemical nitrogen, phosphorous, potassium (NPK) fertilizer. Majority of soil and food on the planet today has become contaminated and depleted of many vital nutrients.

In nature, water carries minerals and other beneficial substances in an organic form via carbonic acids that develop as water attracts CO_{2 from} the air, and via. humic/fulvic acids from runoff through soil and organic vegetative matter. The carbon-based structure of fulvic acid binds with inorganic minerals to create organic acid complexes that are readily bioavailable for uptake by plants and other life-forms (biochemically active and recognizable nutrients). In addition to this important role as a nutrient chelator, fulvic acid also assists with cellular metabolism, restores electrical balance as an electrolyte, scavenges free radicals as an antioxidant, buffers pH, removes heavy metals and binds radioactive substances into neutral molecules. Humic acid also has a range of extraordinary benefits.

One aspect of the present invention combines humic/fulvic acid with the full spectrum minerals, and this core blend is made even more potent and effective through incorporating the paramagnetic force of certain volcanic rock types. Paramagnetism is associated with increased soil fertility, amplifying the electrical charge of the plant system, thus enabling the roots and leaves to function and metabolize at a higher rate of activity. This paramagnetic humic organic-mineral blend is then further combined with a variety of other biostimulants (including soil conditioning bentonite clay, beneficial soil bacteria, root extending VAM fungi, kelp rich in phytohormones, among other ingredients) to create additional synergistic beneficial interactions and optimal bio-availability/nutrient uptake of the mineral elements.

This may be used to plant growth, natural immunity and resilience to change, as well as improve the condition of the soil and protect the soil food web and larger ecosystem (compared to NPK fertilizer that chemically depletes nutrients, degrades the soil structure, kills beneficial organisms and causes pollution over the long term).

These superior results may be obtained without also relying on animal by-products (ABPs) still common in the organic agricultural industry, which can have adverse health, ethical and environmental impacts.

Inorganic minerals, carbon-based organic materials and microbial inoculants are usually found in the marketplace as separate products. There are some technical production challenges related to combining these ingredients, including microbe heat sensitivity and maintaining their survival and shelf life in powder, granular and liquid formats. Applicant will adapt the manufacturing equipment and process to improve survival and delivery of microbes. Applicant may incorporate them into a granule coating of alginate matrices (or alternatively alginate beads), impregnating microbes into ceramics/biochar, using molasses as a dietary carbohydrate, and may use other methodologies and carrier substances such as cocopeat, perlite, rice/wheat bran and vermicompost when appropriate.

Some of the product ingredients have known ability to bind or break-down environmental contaminants, and therefore the synergistic benefits should be substantial for remediating toxic soil, restoring natural habitat, purifying water, treating sewage and neutralizing radiation/EMF in our composite product.

Manufacturing process for liquid concentrate will also incorporate vital life force technology (innovative vibrational charger/subatomic energy activator) that further improves the bioavailability of the core mineral-fulvic complex. This vital force technology imprints subtle energetic information to enhance the cellular functions and to restore harmonious equilibrium of plants, animals and humans. For example, in agricultural applications, the information imprints can be derived from essential mineral types, flowers/herbs, periodic elements and environmental forces that are vital to soil health, aerobic processes of decomposition and root growth. Life force in organisms is manifested as a light emission “biofield”, which can be measured with sensitive devices. Applicant's vital force technology process includes first removing heavy metals, other contaminants and chlorine. Chlorination destroys natural water structure and organic acids (creating toxic trihalomethane by-products). Then re-structuring and further purifying of liquid back into crystalline form is done by using black mica and ancient shungite rock (geometric fullerene molecules emit far infrared spectrum with cleansing and harmonizing properties), using industrial vortex energizers and imbuing liquid with other beneficial vibrational qualities.

Some of the product ingredients have known ability to heal physiological imbalances and cure diseases in organisms (plants, animals, humans), and therefore the synergistic benefits for overall health and resilience should be substantial in our composite product. Formulation can be adjusted for direct consumption in animal feed and human medicinal tonics/healing mineral water.

The composite bio-minerals product could also be used as a seed-starting mix and compost booster for crops and landscaping applications, and should enhance the survivability (germination and growth) of woody plant seeds in reforestation/replanting applications.

What follows in the Detailed Description is a break-down by chapter headings of aspects of components of the present invention, used or implemented in whole or in part. Following the Detailed Description are four Tables wherein Table 1 lists Core Mineral Complex, Table 2 lists Core Biostimulants, Table 3 lists Product Application, Media and Microbe Carriers and Table 4 lists Master Ingredient List of Bioavailable Mineral Fertilizer and Derivative Products.

### BRIEF DESCRIPTION OF THE DRAWINGS

FIG. 1 is a map of the world showing areas of soil degradation.

FIG. 2 is a depiction of a water cycle.

FIG. 3 is a depiction of a nitrogen cycle.

FIG. 4 is a depiction of The Soil Food Web.

FIG. 5 is a depiction of The Soil Food Web pyramid.

FIG. 6 is a depiction of a plant and soil ecosystem.

FIG. 7 is a depiction of a Conventional Fertilizer Granule Coating.

FIG. 8 is a depiction of various types of soil.

FIG. 9 is a depiction of a consumer hierarchy between primary consumers and highly level consumers.

FIG. 9a is, in side elevation view, an in-line water filter sold under the trademark GUARD'N GROW.

FIG. 9b is, in perspective view, a vortex water energizer.

FIG. 10 is, in side elevation view, a spiraling copper device.

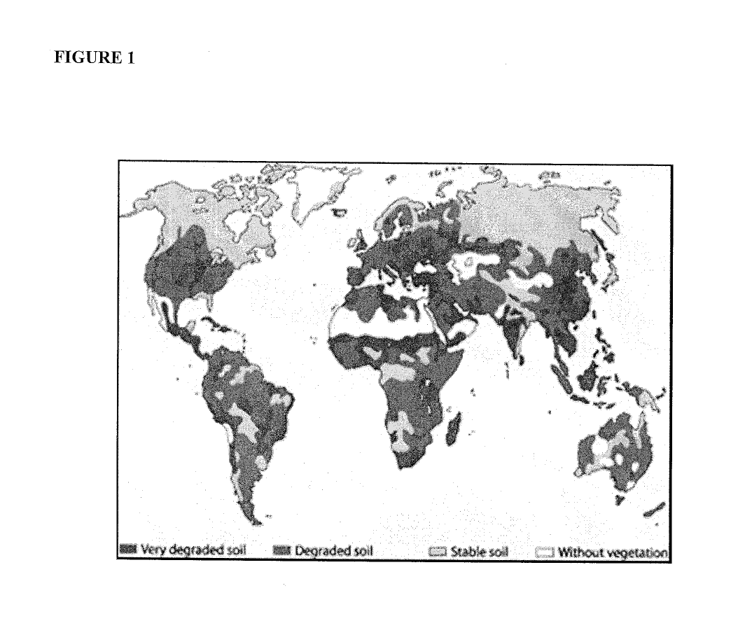

### DETAILED DESCRIPTION

### Chapter 1

### Rock-Based (Re) Mineralization Process

### A) Natural Process

Geological processes of breaking down/transforming rock will gradually (re) mineralize soil over a long period of time. Such processes include volcanic lava and ash dispersal, glacial action, wind erosion, water erosion and tree root action. A full spectrum of minerals and trace elements can be found in healthy soil, plants and animals that are essential to optimal functioning.

### (B) Applicant Enhanced Process

Natural processes of soil mineralization can be accelerated by mechanical crushing and grinding of rock to produce mineral fines (rock dust) for various applications.

Rock dust powder from glacial gravel, volcanic basalt and other rock types can be added to soil to restore 32 to 70+ mineral nutrients in a much faster time frame than natural processes. However, there are problems with fly away dust and lack of uniformity in application; moreover, a crust layer may form. The increased surface area of finer grades of rock dust significantly improves bio-availability to plants, but still relies on healthy soil structure and microbial action to become a slow release source of nutrients.

### Chapter 2

### Paramagnetic Effect

### (A) Natural Process

Paramagnetic materials such as certain types of volcanic basalt and magnetite rocks exhibit a beneficial magnetic energy field in response to the earth's electromagnetic field.

### (B) Applicant Enhanced Process

Paramagnetic rock fines can be added to other rock powders to further enhance soil health, crop yields, plant immunity and other documented benefits. Energy flow between positive (paramagnetic) and negative (diamagnetic) substances improve the plants' access to nutrients and transportation of minerals through the root system.

Dr. Phillip Callahan, entomologist and biophysicist brought paramagnetism into the forefront of sustainable agriculture. According to Dr. Callahan, the enhanced energetic charge of paramagnetism enables the roots and leaves to function and metabolize at a higher rate of productivity, resulting in improved photosynthetic carbohydrate production and other benefits. Apparent differences in insect attraction, due to variations in resonance frequency, also contribute to plant health and resiliency.

Farmers are able to measure the paramagnetism of their soils and can try to improve it through the addition of paramagnetic rock dusts. Paramagnetism is scientifically quantifiable in volcanic-derived material like basalt, diabase, rhyolitic or magnetite rock. Under the influence of Dr. Callahan, the Paramagnetic Count Soil Meter (PCSM) was developed to provide digital measurement using a standard unit of measure (CGS—centimeter-grams-seconds) to confirm the value of the rock source being assessed.

### Chapter 3

### Carbon-Based Humic/Fulvic Acids are Keys to Mineral Chelation for Nutrient Uptake, Remediation of Toxins and Other Benefits

### (A) Natural Process

In nature, water carries minerals in carbon-based organic acid forms such as carbonic acid (developed from carbon dioxide in the air) and fulvic/humic acids (obtained from soil humus). When high turbidity runoff floods over banks, it picks up fulvic and humic acid from the forest leaf litter and soil humus layer. Fulvic acid can bind with more than 60 inorganic minerals/trace elements to create organic fulvic complexes that are soluble, biochemically active and recognizable for uptake by plants (nutrient chelation).

Water containing mineral-rich silt and humic/fulvic organic acids seasonally fertilize alluvial plains. This process has created the world's greatest agricultural areas such as the nile river, mekong river, ganges river and yangtze river plains and deltas.

Unfortunately, many rivers across the world are being altered by modern dams and channelization, and water treatment/filtration systems often remove and/or destroy the natural organic acids critical to soil and plant health. When water-borne organic acids are combined with chlorine treatment, trihalomethanes are formed as toxic by-products.

### (B) Applicant Enhanced Process

The natural processes of forming beneficial organic acids for nutrient chelation can be accelerated by adding humic/fulvic substances derived from ancient coal deposits (leonardite, lignite, humalite weathered sub-bituminous coal, etc.) to soil as an amendment/conditioner for agriculture. In addition to the important role as nutrient chelator for plants, humic/fulvic acids also assist with cellular metabolism, restore electrical balance as an electrolyte, scavenge free radicals as an antioxidant, buffer ph, tie up toxins like heavy metals and bind radioactive substances into natural molecules. They increase water infiltration and water-holding capacity of soil, enhance plant resiliency, root growth and seed germination. Water treatment applications range from removing odours to keeping irrigation lines clean.

Refined fulvic acid has smaller molecular size and is ideal for spray foliar applications and even as an oral health supplement for livestock, pets and people.

### Chapter 4

### Pure Seawater/Salt Solids Provide Additional Soluble Trace Elements and Active Organic Substances that Catalyze Microflora Symbiosis and Reestablish Biological Equilibrium

### (A) Natural Process

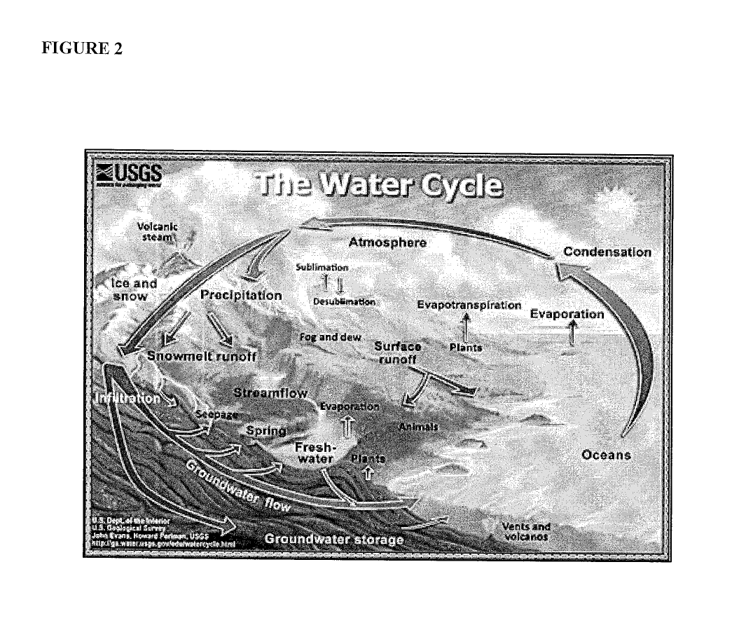

In nature, a timeless water cycle illustrated in FIG. 2, empties rivers, streams, surface runoff and ground water back into the ocean as the beginning and the end destination. Seawater has a complex composition of chlorophyll rich phyto-plankton (microalgae), active humid/fulvic organic compounds along with 92+ known inorganic minerals/trace elements of the periodic table.

The minerals/trace elements in seawater are perfectly proportioned and balanced to sustain biological life, at essentially the same ratios as blood. Sea life living in pure and balanced ocean water is seemingly immune to cancer and other degenerative diseases. Dr. Rene Quinton did experiments showing that seawater could be used to cure various medical conditions in animals and humans. He developed a seawater extract that was used for transfusions in place of blood plasma in World War One. Today his oral and spray solutions are called Quinton Isotonic/Hypertonic pure marine plasma, harvested from areas with vortex plankton blooms (biocenosis). The primordial nature of seawater makes it a natural wellness aid for maintaining a balanced internal/external “bio-terrain”.

Dr. Schuessler a German Biologist discovered that 12 basic cell salts are the physical basis of all healing (an additional 15 salts were discovered later by his pupils). If these micronutrient salts cannot be ingested directly or from food grown in healthy soil, then deficiencies and disease will follow.

### (B) Applicant Enhanced Process

Applicant recycles the valuable seawater nutrients back to the land where they can be used for agriculture, health supplements and other applications. Sea salt solids can be derived from either mined ancient deposits (Utah, Himalayas), natural salt beds (Celtic, Dead Sea, Baja Calif.) or other evaporation/desalination processes.

Dr. Maynard Murray's pioneering book “sea energy agriculture” provides over a century of well-documented research showing that the 92+ elements and organic content of seawater and sea salt concentrates can have profound positive effects on both plant and animal life. Dr. Murray spent decades doing agricultural research with both plants and animals to demonstrate the many benefits that can be obtained. Recently there have been three schools of thought as to whether it is best to use pure seawater plasma (Quinton), to keep sea salt solids in the natural composition (Sea-Agri Inc.), or to create a concentrate that removes 95% of the sodium chloride (ambrosia technology llc sea-crop).

Depending on the application, applicant is combining either seawater or salt solids with other ingredients to provide the highest possible number of elements for optimal soil bacteria/fungi symbiosis and plant health. Benefits include: improvements in nutrient and water uptake, reduced drought stress, increased root length, greater plant growth and yield, plant disease/insect resistance, improved soil structure and porosity, higher vitamin sugar/protein levels, etc. The solubility of sea solids is ideal for liquid applications to field crops, pasture and feed for livestock and poultry, foliar spray, drip irrigation and hydroponics.

### Chapter 5

### Natural Rock Macro-Minerals and Soil Conditioners to Boost Agricultural Production and Correct Regional Deficiencies and Contamination

### (A) Natural Process

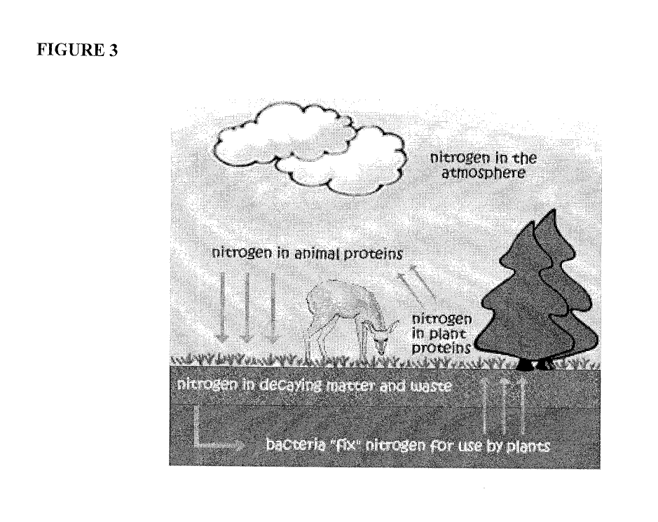

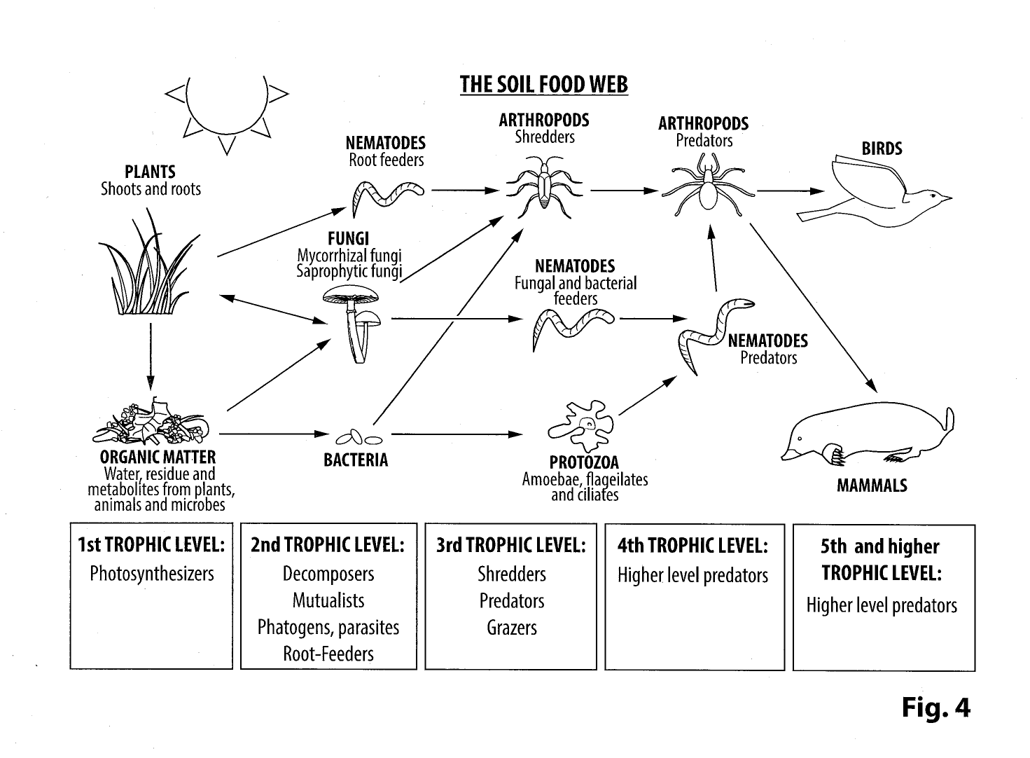

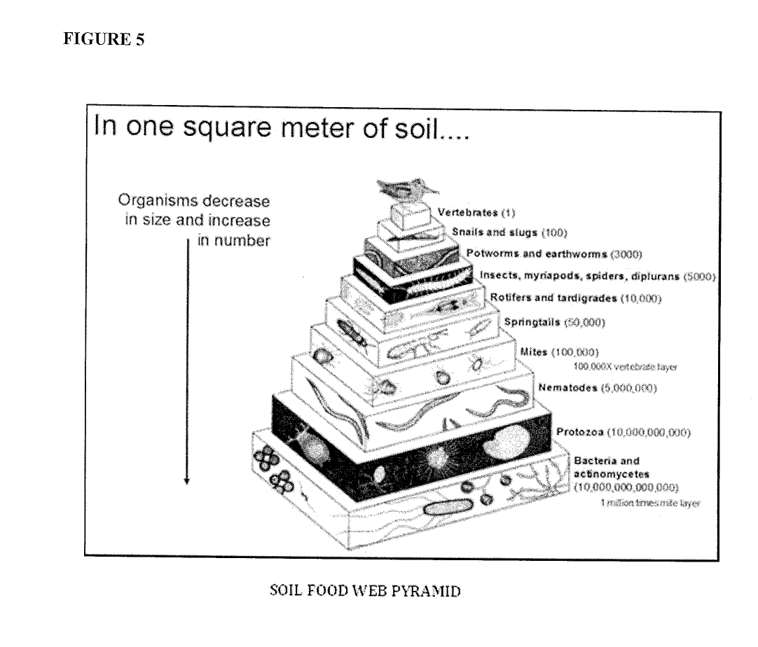

In nature, geological and climatic conditions influence soil texture/structure and the development of associated ecosystems. There can be regional deficiencies in macro-minerals like calcium, phosphorus, magnesium and potassium, and some macro-minerals like nitrogen rely on complex natural cycles. The nitrogen balance in nature, for example, is illustrated in FIG. 3. This natural variation can be further impacted (both positively and negatively) by the building infrastructure, land use practices and industrial by-products of human settlements.

### (B) Applicant Enhanced Process

Agriculture was essentially invented to domesticate plants and animals and enhance the natural productivity of soils. Healthy soil can normally be remineralized with basalt/glacial gravel dust, sea minerals and humic substances alone. However, for more depleted and degraded soils or intensive cropping, conditioning clays and key macro-elements can address imbalances and boost yield. Applicant avoids chemicals and animal by-products in the sourcing.

Bentonite Clay contains not less than 70% montmorillonite (superfine flakey aluminosilicate). It is formed from decomposed volcanic ash and contains more than 70 minerals/trace elements. Bentonite is used as a drawing and binding agent for both medical detoxification and remediation of environmental pollution. The molecules hold a strong negative ionic charge, and they are attracted to substances that hold a positive charge like toxic contaminants. The clay helps balance body pH and stimulates blood circulation. It can dramatically reverse soil degradation in agricultural and forestry applications, while preserving soil moisture and nutrients. This natural humectant contributes to drought resistance, crop/tree seedling growth, reforestation or afforestation in deserts and arid regions. Bentonite can save large amount of water and fertilizer and related costs of maintaining these inputs. The special properties of bentonite are an ability to form thixotropic gels with water, an ability to absorb large quantities of water, and a high cation exchange capacity. It can also absorb pathogenic viruses, herbicides and pesticides. Pozzolan, Zeolite and Kaolin (China Clay) can be used for similar soil applications, while Gypsum and Perlite have high permeability/low water retention to prevent compaction.

### Applicant's Natural Macro-Mineral Boost

Soft Rock Phosphate is a untreated colloidal clay that lies between layers of hard rock phosphate, which is washed off into settling ponds during the mining process. It contains valuable calcium, silica, trace minerals in addition to essential phosphorus, which is lacking in most soils. This non-toxic additive is ideal for fruiting and flowering plants, stimulates strong root formation, improves soil structure, hastens crop maturity and encourages earthworms and soil bacteria. It becomes more readily available to plants than hard rock phosphate and holds calcium in the root zone.

Calcium Carbonate (Calcitic Lime) or Calcium Sulfate (Gypsum) can be pulverized and used as a source of extra calcium and conditioner to neutralize overly acidic soils. Gypsum can also be used in ameliorating high sodium soils and preventing crusting.

Potassium Bearing Rock (K-Feldspar, Glauconite and Langbeinite) Langbeinite is a type of underground salt rock deposit (potash) with the advantage of having essential K, Mg, and S all contained within it. Potassium bearing rocks do not in natural state have toxic by-products, and also aid in securing N (nitrogen).

### Chapter 6

### Bioactive Plant Hydrolysates and Algae-Derived Extracts/Meals to Optimize Tissue Growth, Nutrient Absorption and Stress Resilience

### (A) Natural Process

In nature, the slow processes related to decomposition of vegetative and animal matter contributes to the bio-availability of nutrients, provides hormonal/enzymatic action and stimulates other beneficial interactions.

### (B) Applicant Enhanced Process

Obtaining the beneficial natural by-products of plant decomposition can be accelerated by utilizing plant hydrolysates and algae-derived extracts/meals in fertilizer or nutritional products. Animal by-products and fish hydrolysate (while efficient sources of protein) have some undesirable characteristics and are thus avoided by Applicant.

Plant-Based Protein Hydrolysates (Amino Acids and Peptides)—

There has been an unprecedented demand for inexpensive plant-derived protein hydrolysates in recent years, owing to their various agricultural and nutritional applications. Protein hydrolysates can be prepared by enzymatic or thermal hydrolysis of plant residues. Bioactive protein amino acids and peptides are the “building blocks of life”. They can be derived from alfalfa, carob germ, algae, wheat bran, soy, rapeseed, sunflower and barley to be taken up by plant roots and have the following special effects for agriculture: improved plant nutrient uptake and yield, stimulation of carbon metabolism and nitrogen assimilation, increased plant defenses to biotic and abiotic stress, and decreased plant toxicity to heavy metals. Protein hydrolysates for animal feed and human nutrition, derived from the same crop residues or from milk (whey and casein), assist in muscle gain and have important antioxidant and anti-inflammatory capabilities. These amino acids and peptides are key ingredients in energy drinks and sports nutrition products.

Kelp and other Seaweeds are multicellular marine algae containing between 60-70 essential minerals and trace elements, as well as vitamins, natural chelating agents, and amino acids beneficial for agriculture. Kelp is also an excellent source of cytokinins and auxins, both of which stimulate plant growth (phytohormones). The cytokinin hormones improve soil tilth, regulate cell division and cell wall formation, increase photosynthesis and chlorophyll production, improve root and shoot growth, and delay senescence in the fall (when plants prepare for winter, dropping leaves, losing colour, etc.). The auxin hormones have a primary role in coordination of many growth and behavioral processes in the plant's life cycle and are essential for plant body development stimulating rooting and fruit formation. While auxins can be chemically synthesized as indole-3 acetic acid, kelp is an effective natural alternative without any known side effects. Kelp can be readily obtained as a meal product for soil application providing organic matter and soil conditioning properties, or applied in a concentrated liquid extract form.

Kelp and other types of seaweed are also increasingly being recognized as an important natural source of vital nutritional requirements for animal feed and human health. Recent attention on the diets of cultures with a history of health and longevity has also emphasized the role of sea kelp. The Japanese in particular have attracted much attention as sea kelp traditionally accounted for as much as 25% of their diet. It has been gaining popularity in Australia and the Western world as a unique natural tonic and the richest known source of iodine, vital in the function of the thyroid gland and metabolism. Kelp also contains magnesium, calcium (highest natural concentration), iron, copper, potassium, zinc and natural sea salt. Kelp contains fiber, protein, vitamins A, B, C and E, and beta-carotene (an which may play a role in cancer prevention). The sea kelp nutrient profile can be between 10-20 times greater than that of land vegetables, depending on the environment in which it grows. If harvested from unpolluted marine waters, this complete nutrition becomes invaluable.

Phytoplankton and Zooplankton (Microalgae) have some similar nutrients and benefits, with the added advantage of being able to be cultivated on land in aquaculture hatcheries.

### Chapter 7

### Microbial Enhancements to Support the Plant and Soil Food Web Ecosystem

### (A) Natural Process

In nature, plants live in symbiotic relationship with a myriad of micro-organisms that are the basis of a larger soil food web ecosystem. These microbes fix and solubilize essential nutrients for the plants, as well as perform other beneficial functions.

### B) Applicant Enhanced Process

Soils degraded by intensive land uses and chemical contaminants often lack beneficial micro-organisms. Applicant products inoculate the beneficial bacteria, fungi and other microbes back into the degraded soil.

Endo and Ecto Mycorrhizae Fungi Mycorrihizae literally means “fungus-root” and defines the mutually advantageous relationship between the specialized soil-inhabiting fungi and plant roots. The best known mycorrhiza for agricultural applications is called Vesicular Arbuscular Mycorrhizae (VAM). Endo- and ecto-mycorrhizal fungi symbiotically colonize the roots of the majority of terrestrial plants including trees, vines, ornamentals, crops and pasture plants (95%). Only 5% of plants or plant groups do not respond to the mycorrhizal fungi. The fungi attach to the plant roots and function as an extended root system for the plant, greatly increasing the absorptive surface area of the roots. The fungi provide nutrients such as phosphorus, zinc and silicates to the plants. In exchange, the plants provide sugars (derived from photosynthesis in the plant leaves) and organic compounds for the fungi via root secretions. One popular brand of VAM, for example, claims to double the rate of root establishment, reduce watering needs by 30%, increase survival by 75%, enhance soil structure and prevent erosion.

Beneficial Bacteria and Yeast are very useful to people, agriculture and industry, and can be found almost everywhere including within the human gut as an integral part of digestion. Probiotic feed additives are also similarly used to improve animal health and performance. Many types of bacteria are employed in the production of food products including dairy products such as yogurt, sauerkraut, and fermented meat products such as summer sausage, miso and vinegar.

Bacteria also help fix carbon and nitrogen in the soil (See FIG. 3) and are responsible for decomposing organic materials, which returns important nutrients back to the soil. Specialized microbes for agricultural applications (microbial inoculants) can help control release nutrients from the mineral fertilizer and soil matrix itself. Increase in microbial activity equals increase in nutrient bioavailability. Microbes are also being used to neutralize contaminants in environmental remediation applications. Inoculants were originally developed using peat slurry; now more sophisticated carriers are being used. Strains can be kept in a dormant state to extend shelf life, then activated with water and blackstrap molasses. The wide range of microbial activity in the soil includes: nutrient fixers, nutrient builders, growth hormones, decomposers, protecting bacteria and soil conditioners. More specifically, microbe-based technologies for agriculture may incorporate one or more these strains:

a) Actinomycetes (assists in soil health and nutrient cycling)

b) Azospirillum (free-living Nitrogen fixer, converts atmospheric N, produces growth promoting substances like indole acetic acid and gibberellins)

c) Azotobacter (produces plant growth regulators)

d) Bacillus varieties (N fixer, nutrient cycling, decomposition, enzymes, soil conditioning and structure)

e) Phosphobacter (coverts Phosphorus into plant available P for vigorous growth)

f) Pseudomonas (protect plants against pathogenic fungi in root zone)

g) Rhizobium (legume Nitrogen fixer)

h) Streptomycetes (protects against pathogenic bacteria)

i) Saccharomyces (yeasts that convert carbon dioxide into sugars within the soil)

j) Trichoderma (protects against pathogenic fungi, controls soil diseases, nutrient cycling)

Effective Micro-organisms (EM) are consortia of lactic acid bacteria, purple phototrophic bacteria and yeast with a range of agricultural, forestry and environmental remediation applications.

### Chapter 8

### Core Mineral Complex and Biostimulants are Combined Synergistically with Product Mediums and Microbe Carriers that are Application-Specific to Provide Whole Integrated Solutions for Agriculture, Health and the Environment

### (A) Natural Process

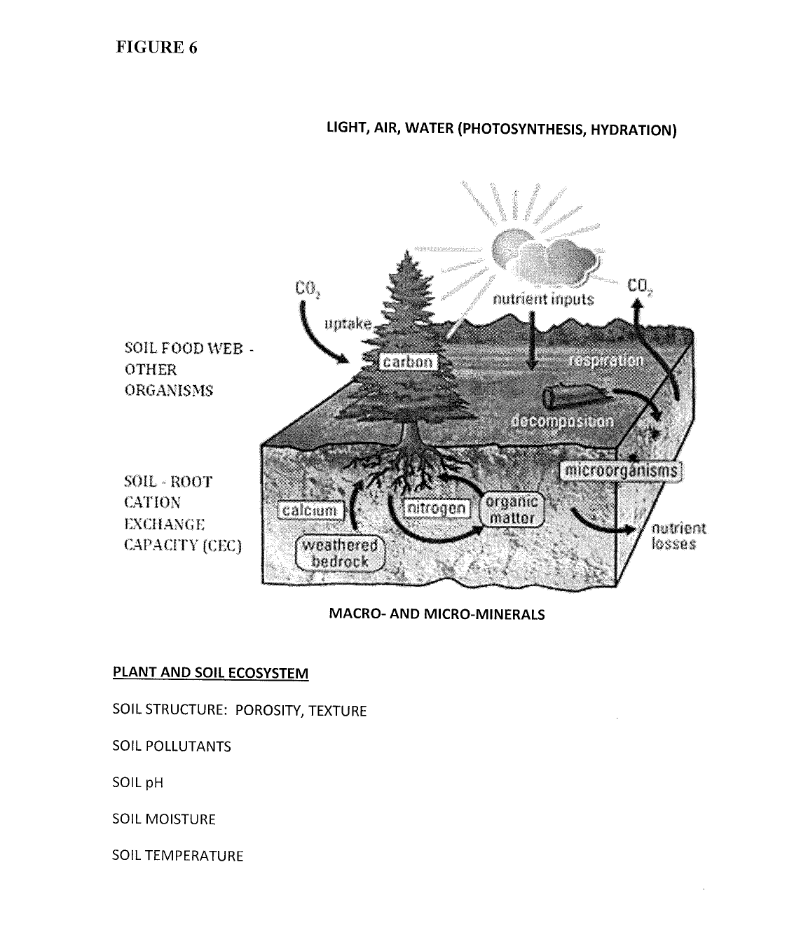

In a healthy ecosystem such as depicted in FIG. 6, the natural cycles, mineral elements and bio-stimulating components gradually evolve into a symbiotic functional relationship. However, in many ecosystems today soils are seriously polluted and lack some of their essential components, which in turn impacts plant health and the stability of the entire food web ecosystem.

### (B) Applicant Enhanced Process

Applicant ensures that a full-spectrum of essential mineral and carbon-organic nutrients for soil and plant health are incorporated into composite blended liquid, powder and granular products. Special consideration is given to promoting bioavailability, neutralizing pollutants, retaining moisture, improving the soil structure and incorporating beneficial microorganisms. Degraded soils can thus be rapidly regenerated through these synergistic effects. Enhancing the purity and energetics of water creates optimal outcome for the soil treatments.

### Chapter 9

### Powder Blend Fertilizer—Core Minerals, Biostimulants and Microbe Carrier are Combined Uniformly for Dry Applications

### All Purpose Powder Blend Fertilizer

### Function:

Suitable for custom hand or simple spreader applications for potted plants, gardens, tree nurseries and greenhouses. Dry powder also has some applications in crop spraying by planes/drones, or aerial product drops into remote resource development zones.

### Powder Blend Ingredient List:

a) Glacial Gravel Dust/Paramagnetic Basalt Powder

b) Soft Rock Phosphate/Calcium Carbonate/Potassium-Bearing Rock Powders c) Seawater Solids

d) Fulvic Acid/Humic Acid Powders

e) Bentonite Clay with Diatomaceous Earth Powder

f) Endo/Ecto Mycorrhizae Fungi Spores g) Kelp Meal Powder

h) Microalgae and/or other Protein Powder

i) Select Beneficial Bacteria, Yeast and/or Microbial Consortia Ceramic Powder j)

Stabilized Rice/Wheat Bran Carrier

k) Organic Blackstrap Molasses Powder

### Manufacturing Process:

Stabilized rice/wheat bran free of pathogens is used in manufacturing so that only the beneficial bacteria use it. Molasses powder is used as a carrier food source. Bentonite clay from geological formation is used that includes diatomaceous earth for its anti-caking properties. Product particles must be sufficient size and weight to avoid “fly away” dust drifting (which is not only a waste of material but can be a respiratory health risk); at the same time particles cannot be too large as they need to become bioavailable to plants for the growing season.

### Aerial Topdressing—Powder Blend Fertilizer for Agricultural Aircraft

A specific utilization of aerial application is the spreading of fertilizers over farmland or agri-forestry plantations with the use of agricultural aircraft. Aerial topdressing may be done by aircraft or unmanned aerial vehicles (drones). To reduce drift of the sprayed materials, agricultural pilots attempt to fly just above the crops/plantations being treated. Most aircraft have spraying systems attached to the trailing edges of their wings, and pumps are usually driven by wind turbines.

### Chapter 10

### Coated Granular Fertilizer—Core Minerals and Biostimulants are Granulated with Double-Layered Coating that Contains Microbes and Slow Releases the Nutrients into the Soil

### All Purpose Coated Granular Fertilizer

### Function:

Suitable for dry broadcast mechanized equipment farming, lawn fertilizer spreader and other applications in which an even distribution and slower release of product nutrients is required.

### Granular Blend Nutrient Core Ingredients:

a) Glacial Gravel Dust/Paramagnetic Basalt Powder

b) Soft Rock Phosphate/Calcium Carbonate/Potassium-Bearing Rock Powders

c) Seawater Solids

d) Fulvic/Humic Acid Powders

e) Bentonite Clay

f) Kelp Meal Powder

g) Microalgae and/or other Protein Powder

### Granular Manufacturing Process/Coating:

The core mineral and biostimulant ingredients (nutrient core) are processed through granulation equipment, using pressure compaction agglomeration without chemicals, as well as bentonite and/or zeolite as the binding agent. Heat and intense compaction of granules in manufacturing process may affect viability of many beneficial bacteria and fungi. Therefore dormant spore microbes will be added to final stage spray coating of granules instead, which also must be dried without using technologies like microwave. Coating will also contain mineral/carbohydrate/sugar substances for microbes to feed on as they become activated by soil moisture and start populating as a result. Microbes may also be impregnated into alginate beads instead of or in addition to coating. However, different weight/densities of alginate microbial beads blended with mineral composite granules may influence uniformity of blended product (potential separation and settling of product granules can be remedied).

### Microbe-Impregnated Granule Coating:

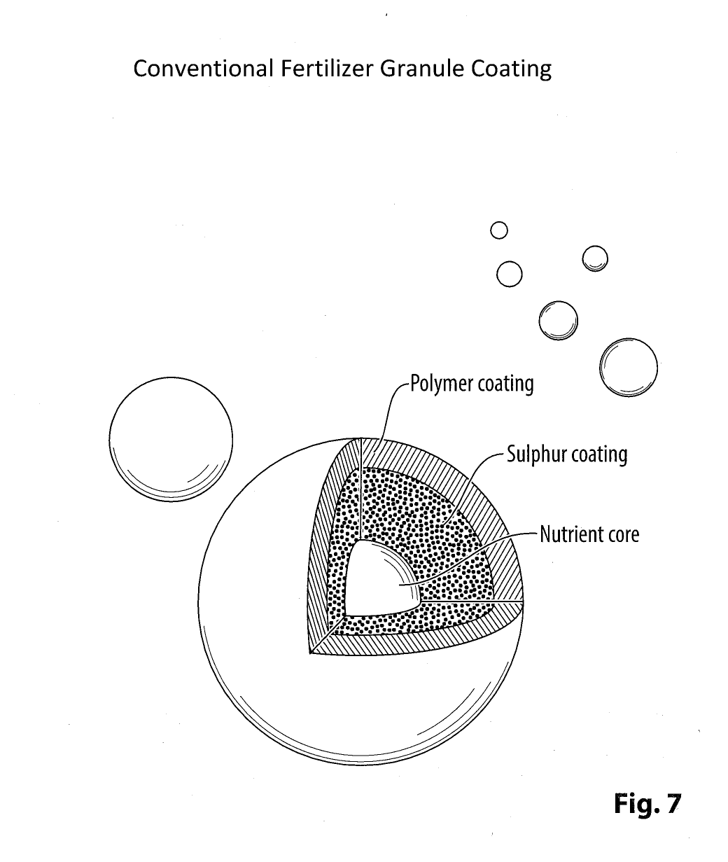

Coating on the granule is generally desirable for slow release, dust control, enhancing flowability and minimizing moisture pick up, among other benefits. See FIG. 7 for a prior art conventional fertilizer coating; Applicant's microbe impregnated granule coating with be an eco-friendly innovative modification. A non-toxic food grade coating will be used to add the beneficial microbes that may otherwise be affected by heat and other processing conditions. Natural alginate, biodegradable biomass-based polymer, blackstrap molasses, natural gums and waxes, among other substances, will be used as suitable coating ingredients that can also maintain stable microbial populations with sufficient shelf life. Microbial inoculants added to the coating may include Endo/Ecto Mycorrhize fungi spores, Select Beneficial Bacteria, Yeast and/or Microbial Consortia Ceramic Powder.

### Chapter 11

### Liquid Plant Fertilizer—Core Mineral Complex and Biostimulants are Powdered Ultrafine with Special Processing Adaptions for Maintaining Microbial Viability and Ingredient Potency in Solution

Foliar Feeding Function (spraying the leaves) is considered among the major techniques used for plant nutrition, supplementing the soil application. Foliar spraying is a reliable method of feeding plants when nutrients absorption by the plant roots is inefficient. Very soluble fertilizer and pure nutrients are essential for achieving the best performance from this application method.

### Applicant Liquid Plant Fertilizer

### Function:

Suitable for greenhouses, hydroponics, vertical gardens, fertigation, foliar spray and other liquid agricultural and agro-forestry applications.

### Liquid Ingredients:

a) Ultrafine Soluble Glacial Gravel Dust

b) Ultrafine Soluble Paramagnetic Basalt Powder

c) Ultrafine Soluble Seawater Solids

d) Ultrafine Soluble Bentonite Clay

e) Ultrafine Soluble Soft Rock Phosphate

f) Ultrafine Soluble Calcium Carbonate

g) Ultrafine Soluble Potassium Rock Powder

h) Micronized Fulvic/Humic Acid Liquid

i) Cold Processed Kelp Liquid

j) Beneficial Bacteria and Yeast

k) Mycorrhizae Fungi Spores

l) Organic Blackstrap Molasses Liquid

m) Crystalline Structured Water

n) Green Microalgae Water Extract

Relative proportions of fulvic and humic vary depending on specific application. The beneficial bacteria and mycorrhizae spores will not be included in the foliar spray as their action is for the soil and may damage the leaves. Organic Blackstrap Molasses liquid is a microbial activator for soil application, and enhances spray adhesion to leaf surfaces.

Fertigation is the application of fertilizers, soil amendments or other water-soluble products through an irrigation system. Nutrients can be added or deficiencies corrected as may be detected in plant tissue analysis. Fertigation is usually practiced on high-value crops such as vegetables, fruit trees, turf and ornamentals. The water supply for fertigation is kept separate from the domestic water to avoid contamination.

Greenhouse Production can be soil based or utilize soil-less hydroponic solutions. For the hydroponic growing systems the fertilizer particle sizes must be ultrafine and fully soluble in cold water. Terrestrial plants may be grown with their roots in the fertilizer solution only or in an inert medium, such as perlite, coir or gravel. Adding more complete bio-mineral nutrition to hydroponic plants may improve their yields, nutrient density, resilience and other aspects of health and vitality. Other hydroponic applications may include rooftop gardens, green walls and other contemporary urban agri-landscaping.

### Manufacturing Process:

Advanced rock grinding techniques, which may approach innovative nano scale, are employed to create the ultrafine powders that can blend effectively with the seawater solids in liquid concentrate solution. Normally the rock dust is not soluble in water. The biostimulants also have to be micro filtered and cold processed to ensure that they too can be dissolved into the solution while still retaining their potent qualities.

### Chapter 12

### Forestry Regeneration

### Core Minerals and Biostimulants, Microbes and Seeds are Combined into Pellets or Mulch Slurry to Provide Living Soil Support for Re-Seeding and Re-Planting Efforts Forestry Regeneration Pellets

### Function:

Suitable for tree nursery and agro-forestry operations as well as reforestation or afforestation of large tracts of land. Can be spread by hand, mechanized equipment, or by airplane/unmanned aerial vehicle application.

### Ingredients:

Refer to All Purpose Powder Fertilizer ingredients, but with higher concentrations of ecto mycorrhizae spores for woody species. Also non-GMO seeds of tree species that are desired for reforestation will be added. May also include wood sawdust or other biomass residue fibre as filler medium for pellets. Biochar may be substituted for rice/wheat bran husks as the microbe carrier.

### Manufacturing Process:

Aerial application would require that pellets be bound with sufficient density for uniform distribution without flyaway particles. A suitable binder will be used (1 to 3% of molasses and colloidal clays), then the composition is pressed under high pressure agglomeration in pelletizing machines or extruders to form cylindrically shaped pellets. Seed survival will be enhanced by the core bio-mineral ingredients that are mixed in with the biomass.

Landscape Revegetation Hydroseeding—(or hydraulic mulch seeding, hydro-mulching, hydroseeding) is a planting process that uses slurry of seed and mulch. The slurry is transported in a tank, either truck or trailer-mounted and sprayed over prepared ground. Helicopters have been used to cover larger areas. Aircraft application may also be used on burned wilderness areas after a fire. Applicant's hydroseeding blend would combine the core minerals and biostimulants with a nontoxic natural tackifying agent and colour dye added to the seed mulch slurry.

### Regional Forest Soil Type Adaptation—

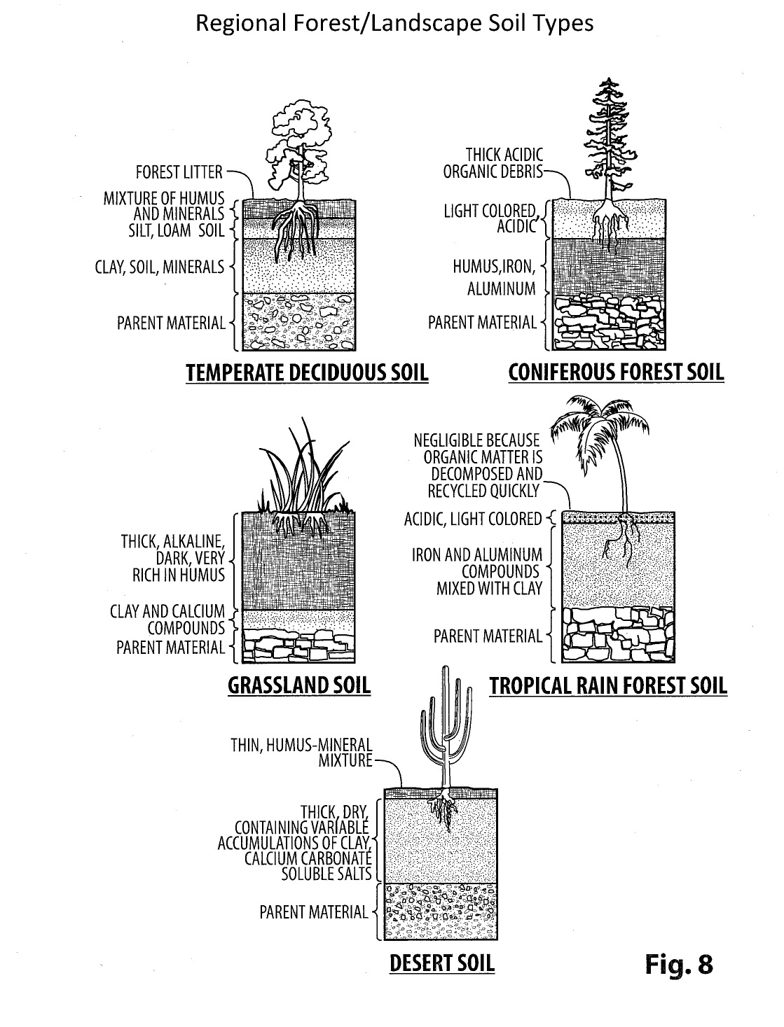

The blends are adapted to major differences in soil conditions and microbial culture species (desert, rain forest, temperate, etc.) See FIG. 8.

### Chapter 13

### Environmental Remediation—Core Mineral and Biostimulant Ingredients are Boosted by Pollutant-Neutralizing Microbes and Carrier/Mediums

### Examples of Environmental Remediation Applications:

Agricultural/Industrial Pollution Zones: Countries around the world are experiencing increasing levels of soil and water contamination. In China, for example, at least one fifth of arable land is polluted with inorganic chemicals like cadmium, nickel and arsenic (Yale Centre for Environmental Law and Policy, 2014). Toxic heavy metals need to be neutralized and the mitigation of radioactive contaminants in soils is also a concern in some nuclear energy zones.

Urban Brownfields: New planned neighbourhood developments in city regions are being created on lands previously utilized for old ports, industries or transportation networks requiring soil remediation first.

Mining: Tailing ponds, quarries and other impacts of mining and aggregate activity require a comprehensive reclamation strategy after closure, involving removal of hazards, restoring the soil cover, rebuilding natural water channels and comprehensive landscaping.

Oil and Gas Spills: Soil and waterways contaminated by spills require immediate intervention and longer-term restoration activities for the affected ecosystems.

Sewage Treatment: Neighbourhood scale biological treatment, such as in a SAS greenhouse-pond water and nutrient reclamation system, is replacing centralized chemical treatment plants in many urban-rural fringe areas. Municipal sewage bio-solids can be reprocessed into new landscaping products. Chemically treated water can be naturally restored to a pure and energetically vitalized state.

Nuclear Radiation Contamination: Both soil and water can be contaminated by nuclear fall-out and leakages with serious environmental and health risks, and require the intervention of neutralizing (binding or transformative) substances.

### Ecological Restorer

### Function:

Suitable for contaminated waterways and land sites, and for any soil that has been seriously degraded by intensive chemical agriculture, resource extraction and other industrial activities. Can also be combined with substance like sewage bio-solids to improve functionality and neutralize residual toxins.

### Ingredients:

Similar to Powdered, Slurry and Coated Granular Fertilizer Blends except using higher concentrations of fulvic and humic acids and microbial species targeted towards particular pollutants. Also will include pozzolan, shungite and/or black mica for extra strength in binding heavy metals and neutralizing contaminants. Biochar will also be incorporated as a remediating agent and is compatible as a carrier of micro-organisms.

### Chapter 14

### Compost Booster

### Core Minerals, Biostimulants, Microbes and Enzymes can be Blended into Vermicompost (Worm Castings) or Municipal Yard Waste Compost to Produce the Ultimate Topdressing for Lawns and Gardens

### Municipal Compost:

The yard waste piles at municipal landfills can have a natural balance of “green” and “brown” material so that the carbon-nitrogen ratio stays ideally around 30 to one. Water is added to bring the moisture level in the piles up to 65 percent, perfect for composting. The storage piles, called windrows, are turned regularly to make sure there is always a supply of oxygen for the microbes that are hard at work. Temperatures of the piles is taken every two weeks to make sure that decomposition is taking place on schedule. When the piles are ready they are screened to remove any chunks of wood larger than a half inch.

### Vermicompost:

“Vermicast, also called worm castings, worm humus or worm manure, is the end product of the breakdown of organic matter by an earthworm. These castings have been shown to contain reduced levels of contaminants and a higher saturation of nutrients than do organic materials before vermicomposting. Containing water-soluble nutrients, vermicompost is an excellent, nutrient-rich organic fertilizer and soil conditioner. This process of producing vermicompost is called vermicomposting”. (Wikipedia 2014)

### Benefits:

Mixing vermicompost with powdered form of bio-mineral product including suitable microbes and extra enzymes will create a premium topdressing/landscaping product.

Vermicompost's direct positive effects on soil, plant growth, economic and environmental are as follows:

Soil:

a) Improves aeration and enriches soil with micro-organisms (adding enzymes)

b) Microbial activity in worm castings is 10 to 20 times higher than in the soil and organic matter that the worm ingests

c) Attracts deep-burrowing earthworms and improves water holding capacity

Plant Growth:

a) Enhances germination, plant growth, and crop yield while improving root growth and structure

b) Emiches soil with micro-organisms (adding plant hormones such as auxms and gibberellin acid)

Economic:

a) Bio wastes conversion reduces waste flow to landfills

b) Elimination of bio wastes from the waste stream reduces contamination of other recyclables collected in a single bin (a common problem in communities practicing single-stream recycling)

c) Low capital investment and relatively simple technologies make vermicomposting practical for less-developed agricultural regions

Environmental:

a) Helps to close the “metabolic gap” through recycling waste on-site

b) Large systems often use temperature control and mechanized harvesting

c) Production reduces greenhouse gas emissions such as methane and nitric oxide (produced in landfills or incinerators when not composted or through methane harvest)

### Chapter 15

### Animal/Fish Nutritional Pellets

### Fish Farming—

With wild stocks being seriously depleted worldwide and concerns about PCB and mercury contamination, by 2030 nearly two-thirds of seafood worldwide will be farm-raised, according to the World Bank. Closed containment aquaculture systems on land are on the rise as an eco-friendly alternative to open pen fish farming, but still there is a fundamental environmental problem: millions of tons of ocean caught fish like anchovies, sardines and mackerel are still being caught to feed farm-raised fish like salmon—in many cases it takes three pounds of wild fish to grow one pound of farmed fish that rely on feed pellets containing fish meal and oil. While herbivorous fish can live well on pellets made from vegetable plant proteins, oil, minerals and vitamins, innovation is required to develop vegetarian feed for carnivorous fish. The USDA has already proven that eight species of carnivorous fish, white sea bass, walleye, rainbow trout, cobia, arctic char, yellowtail, Atlantic salmon and Coho-Salmon can get enough nutrients from vegetarian sources without eating other fish. However, many leading substitutes for fishmeal being developed utilize wheat, soy, rapeseed, rice and corn in the feed, which are foreign to fish and may result in health complications over the long term.

Applicant brand fish pellets will replicate a more natural aquatic diet, using organic permitted ingredients. A key constituent will be microalgae powder and oil which is rich with Omega-3 oils, proteins and carbohydrates. Phytoplankton algae farms have unlimited scalability, year round fresh supply, allergen and toxin-free, and are cost-effective as well. Contained aquafarming of zooplankton organisms is just emerging. Applicant intends to incorporate these rich zoo plankton nutrients in freeze-dried form, thereby eliminating the need for both fishmeal and substitute grain ingredients. The Applicant's feed pellets for both the herbivorous and carnivorous fish will also contain other core bio-mineral ingredients such as the seawater salt solids, bentonite clay powder, kelp, fulvic acid, key amino acids like taurine, vitamins, dried yeast, seaweed agar gel binder.

### Pelletizing for Animal Feed Applications

### Function:

Animal fodder pellets for horses, cattle, rabbits, goats, chickens, etc. provide mineral, enzymatic, amino acid and probiotic nutritional supplementation for optimal whole health. Organic permitted ingredients, non-GMO.

Ingredients: Core bio-mineral ingredients like seawater salt solids, bentonite clay, diatomaceous earth, fulvic acid, kelp, blackstrap molasses is combined in appropriate ratios with fodder materials. The biomass fodder pellet is made up of plant protein hydrolysate powder, alfalfa meal, hulled seed meal, copra meal, etc. Probiotic bacteria and natural enzymes will be added to aid digestion, using stabilized rice/wheat bran or other carrier. Vegetable, fruit and medicinal herb powders may also be added as appropriate to the animal species and condition being remedied.

Manufacturing Process: 1 to 3% of molasses and colloidal clay serves as binder and then press the blended composition under high pressure in pelletizing machines or extruders to form cylindrically shaped pellets. Need to keep bacteria and enzymes in more dormant state so break down of organic biomass material doesn't occur quickly (decomposition and spoilage issues).

Pelletizing process also must not exceed heat tolerance of micro-organisms, therefore cold-press production methods will generally be used.

### Chapter 16

### Liquid Medicinal Tonic—Energized Water, Minerals and Biostimulants with Healing Properties for Plants, Humans and Animals are Prepared for Consumption as a Liquid Concentrate

### Liquid Medicinal Tonic Applications:

### Function—

Suitable for liquid medicinal tonic to provide essential mineral/trace elements, protein amino acid, enzymatic and probiotic nutritional supplementation. Homeopathic energetic imprinting/herbal essences can be used to help alleviate various medical ailments. Pets and livestock can drink tonic concentrate by adding it to their water dish.

### Ingredients:

Crystalline structured water with dissolved seawater solids, marine plasma seawater or mineral springs water, combined with appropriate quantity of soluble micronized fulvic/humic acid, essential amino acids and microalgae extracts. Probiotic bacteria and natural enzymes added to aid digestion, may be cultured kefir style. Medicinal herbs, fruit extracts and other natural flavours to improve taste.

### Manufacturing Process:

As this liquid product it can be made using the production process employing the Water Purifier and Energizer technology (Chapter 17). The crystalline structured water can be imprinted with the extracted essences or resonant frequencies of healing herbs, flowers and other elements to help resolve specific ailments in plants, animals and people.

Energetic enhancements that can be incorporated into fertilizer and health products relate to subtle information transfer that heals and supports weakened physiology and environments. Homeopathic medicine, herbal tinctures/tonics and related aids have been used to produce vital health in people and animals. Soil amendment products can also be energetically enhanced to improve plant and root growth, seed germination, organic composting, pond water quality, odor reduction, insect resistance, among other benefits. Such innovative processes can infuse energetic information (imprints) into a carrier medium such as water. These imprints are derived from essential mineral types, herbs and periodic elements. While being newly introduced to North America through companies using leading edge quantum physics, transfer of healthy resonant frequencies has been an established technique in traditional Asian, European and Steiner's Biodynamic Agriculture. These techniques are also related to the scientific work of Nikola Tesla, Viktor Schauberger and Wilhelm Reich, among other new energy scientists of the past century.

The beneficial effects of subtle energy enhancements can be documented through the use of kirlian electrophotonic photography, resonant field imaging and orgone life-energy field meters. While this is an emerging science in agriculture that parallels new research in vibrational medicine and quantum physics, the understanding of vital life force energy is ancient and part of the world's wisdom traditions. Such holistic knowledge adds another dimension of analysis and refinement to sustainable ventures that can be practically applied to create superior products. Designing in harmony with natural processes and universal energy patterns requires less effort and materials and amplifies beneficial results. It is through this knowledge that Applicant not only creates products that restore the physical “building block” components that living organisms need to thrive but also enhances their “biofield” light energy.

### Chapter 17

### Water Purifier and Energizer, Select Minerals and Subtle Energy Technologies Incorporated in Applicant Filter Devices Remove Pollutants from Water and Restructure to Crystal Purity

### What's in the Municipal Water Supply?

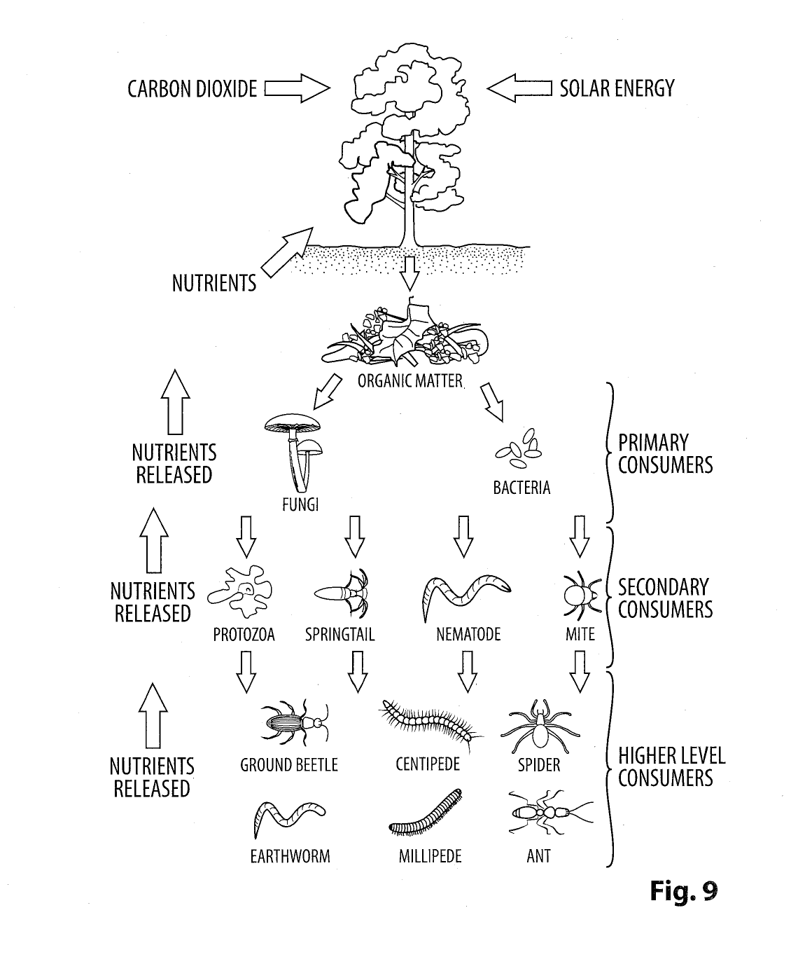

Despite chemical treatment of the water supply, many municipal and rural systems still contain a soup of toxic contaminants such as chlorine, fluoride, lead, mercury, arsenic, PCBs, chromium-6, BPA, birth control pill hormones, drug residues, and so on. To protect human and animal health and ensure that these contaminants do not interfere with the optimal performance of the bio-mineral products, Applicant will provide a special in-line water filter (as seen in FIG. 9a) with innovative mineral media and vortex energizer for both household systems and larger farm, commercial and industrial operations

### Manufacturing Process: —

Applicant creates Crystalline Structured Microwater, free of contaminants, by incorporating a mix of select minerals with energizing properties, such as Shungite (contains “buckyball” fullerenes nano-structure), Black Mica (Biotite) and Magnetite combined with activated carbon and microbial consortia ceramics filter (far infrared frequency). In-line device will also incorporate a new version of the Vortex Water Energizer to re-create the swirling spin flow inside the filter chamber (implosion). Water being structured for the liquid bio-mineral products will also be treated with harmonious sound vibration.

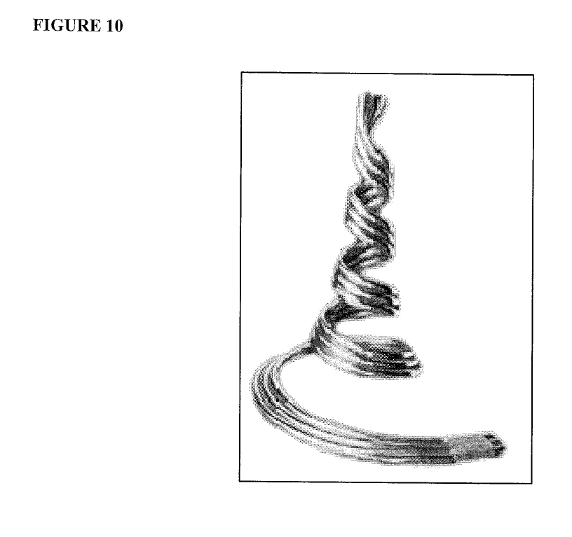

The classic Vortex Water Energizer (as seen in FIGS. 9a and 9b) is a spiraling copper device (as seen in FIG. 10). It contains highly energized water, which has been prepared using a natural process called Implosion. Whilst this process is new to mainstream technology it is actually as ancient as the Universe. Researchers at the UK Center for Implosion Research, among other institutes, are exploring how to restore this vitality principle to normal household or agricultural water, thereby increasing its healing and vital properties. The results of using Vortex Water Energizers are quite impressive:

a) Plants watered with Vortex energized water shows 250% increase in crop yield.

b) Plants required 50% less feeding with Vortex energized water.

c) Pool require 80% less chlorine with a VWE on the water intake pipe.

d) Vortex energized water shows substantially increased geometric structure of water molecule.

e) The Vortex Energizer in ponds increases oxygen and reduces bacterial growth and stagnation.

Living Water is a term coined by Austrian inventors Viktor Schauberger and Johann Grander, and reflected in the more recent work by Dr. Emoto from Japan who documented the microcrystalline structure of water responding to harmonic sound, words and even thought forms, revitalizing and purifying previously degraded and polluted water.

What is claimed is:

1. A Bio-Available Mineral Fertilizer Composition comprising a full-spectrum of essential mineral and carbon-organic nutrients for soil and plant health incorporated into a composite blended media chosen from the group comprising liquid, powder, granular.

2. The composition of claim 1 wherein said blended media is said blended powder media and which includes ingredients comprising:
a. Glacial Gravel Dust
b. Paramagnetic Basalt Powder
c. Soft Rock Phosphate
d. Calcium Carbonate
e. Potassium-Bearing Rock Powders
f. Seawater Solids
g. Fulvic Acid Powder
h. Humic Acid Powder
i. Bentonite Clay, which includes clays chosen from the group comprising Diatomaceous Earth or other clays
j. Endo or Ecto Mycorrhizae Fungi Spores
k. Kelp Meal Powder
l. Microalgae and/or other Protein Powder
m. Select Beneficial Bacteria, Yeast and/or Microbial Consortia Ceramic Powder
n. Carriers chosen from the group comprising: Wheat Bran Carrier or Stabilized Rice Bran Carrier
o. Organic Blackstrap Molasses Powder

[symbol]

3. The composition of claim 1 wherein said blended granular (nutrient core) media includes ingredients comprising:
a. Glacial Gravel Dust/Paramagnetic Basalt Powder
b. Soft Rock Phosphate/Calcium Carbonate/Potassium-Bearing Rock Powders
c. Seawater Solids
d. Fulvic/Humic Acid Powders
e. Bentonite Clay which may include Diatomaceous Earth or other clays
f. Kelp Meal Powder
g. Microalgae and/or other Protein Powder

[symbol]

4. The composition of claim 1 wherein said blended liquid media includes ingredients comprising:
a. Ultrafine Soluble Glacial Gravel Dust
b. Ultrafine Soluble Paramagnetic Basalt Powder
c. Ultrafine Soluble Seawater Solids
d. Ultrafine Soluble Bentonite Clay
e. Ultrafine Soluble Soft Rock Phosphate
f. Ultrafine Soluble Calcium Carbonate
g. Ultrafine Soluble Potassium Rock Powder
h. Micronized Fulvic/Humic Acid Liquid
i. Cold Processed Kelp Liquid
j. Beneficial Bacteria and Yeast
k. Mycorrhizae Fungi Spores
l. Organic Blackstrap Molasses Liquid
m. Crystalline Structured Water
n. Green Microalgae Water Extract

[symbol]

5. The composition of claim 4 wherein said ultrafine ingredients are blended with seawater solids in liquid concentrate solution.

6. The composition of claim 1 further comprising Pozzolan, shungite and/or black mica for extra strength in binding heavy metals and neutralizing contaminants.

7. The composition of claim 1 further comprising bio-char incorporated as a remediating agent which is compatible as a carrier of micro-organisms.

8. The composition of claim 1 further comprising microalgae powder and Omega-3 bearing oils, proteins and carbohydrates.

9. The composition of claim 8, further comprising freeze-dried zooplankton, in fish feed pellets.

10. The composition of claim 1, formed as fish feed pellets which further comprise bio-mineral ingredients chosen from the group: seawater salt solids, bentonite clay powder, kelp, fulvic acid, key amino acids like taurine, vitamins, dried yeast, seaweed agar gel binder.

11. The composition of claim 8, formed as fish feed pellets which further comprise bio-mineral ingredients chosen from the group: seawater salt solids, bentonite clay powder, kelp, fulvic acid, key amino acids like taurine, vitamins, dried yeast, seaweed agar gel binder.

12. The composition of claim 1, wherein dormant spore microbes are added to a spray coating of granules of said composition of claim 1 and wherein said spray coating contains mineral, carbohydrate and sugar substances as food for said microbes as they become activated by soil moisture whereby said microbes start populating.

13. The composition of claim 12, wherein said microbes are also impregnated into alginate beads instead of or in addition to said coating.

14. The composition of claim 12, wherein microbial inoculants are added to said coating and include Endo or Ecto Mycorrhize fungi spores, beneficial bacteria, yeast and/or microbial consortia ceramic powder.

15. The composition of claim 2, wherein said composition consists of all of said ingredients.

16. The composition of claim 3, wherein said composition consists of all of said ingredients.

17. The composition of claim 4, wherein said composition consists of all of said ingredients.
